(19) United States
(12) Patent Application Publication
(10) Pub. No.: US 2013/0291024 A1
(43) Pub. Date: Oct. 31, 2013

(54) APPARATUS AND METHOD FOR PERFORMING VIDEO SCREEN SCRAPE

(71) Applicants: Chad Andrew Lefevre, Indianapolis, IN (US); Martin Vincent Davey, Indianapolis, IN (US); Chaminda Jayamanne, Fishers, IN (US)

(72) Inventors: Chad Andrew Lefevre, Indianapolis, IN (US); Martin Vincent Davey, Indianapolis, IN (US); Chaminda Jayamanne, Fishers, IN (US)

(21) Appl. No.: 13/979,477

(22) PCT Filed: Jan. 18, 2011
(86) PCT No.: PCT/US11/00087

§ 371 Date: Jul. 12, 2013

(51) Int. Cl. H04N 21/81

(52) U.S. Cl. CPC H04N 21/8133
USPC 725/60

(57) ABSTRACT

A method and apparatus for capturing a video frame and scraping the captured frame for data contained therein is provided. The scraping of the frame extracts data from the frame. A user, while watching television, requests a screen capture function. The video frame is stored in a (e.g., advertisement for local store, or frame buffer and further processing is performed to scrape the screen of data contained therein. In one example, text information such as phone numbers, web addresses, etc. can be identified using OCR technology. Once extracted, the information can be provided to the user in many different formats for further use or further processing.

### TECHNICAL FIELD

The present principles relate to set top boxes (STBs). More particularly, it relates method for enabling an STB to perform a screen capture and scrape function.

### BACKGROUND

Often times when one is watching television, an advertisement can catch the user's attention, yet the user does not have enough time to memorize it, or does not have the means immediately available to write down the phone number, address or other identifying information relating to the viewed advertisement.

The concept of capturing data is most commonly known in the scanning of documents and using optical character recognition (OCR) software to pull text out and make the document a searchable digital document. Other known methods include a Ctrl/print screen function with a computer keyboard, where you can take snapshot image of a computer screen. However, in this example, the snapshot is an image containing the selected data, but no further processing is then available to extract data from the captured image.

### SUMMARY

According to an implementation, the present invention enables a user to press a dedicated button to perform a screen capture and a scrape function that provides more than just an image of the screen frame.

According to an implementation, the present invention extracts data contained within the captured screen image (i.e., scrapes the image) and offers it to the user for further use.

These and other aspects are achieved in accordance with the method of the invention wherein the method for performing screen scrape includes identifying whether a screen capture input has been received, saving a frame to a frame buffer in response to a received screen capture input, scraping the saved frame to discover and save textual data contained within the saved frame; and displaying a menu of options to a user in response to their request to see data related to the saved frame.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles can be better understood in accordance with the following exemplary figures, in which:

FIG. 1 is flow diagram of the method for screen scrape according to an embodiment of the invention; and

FIG. 2 is a block diagram of a set top box (STB) within which the present invention can be implemented.

### DETAILED DESCRIPTION

The present principles are directed to Set Top Boxes (STBs) and more specifically to providing a user of an STB with an option to perform a screen scrape function.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudo code, and the like represent various processes which can be substantially represented in computer readable media and so executed by a computer or processor, whether or not such computer or processor is explicitly shown.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

The present invention is herein described with above example in mind. As mentioned above, when one is watching television, often times a phone number or an address is presented in an advertisement, and either the user does not have the time to memorize the same, or does not have a paper and pen to write down the information. In accordance with an embodiment of the invention, the STB is provided with an additional feature to save this frame and use some other processing (e.g., OCR), to search the frame for the text contained therein and save it in a memory or database.

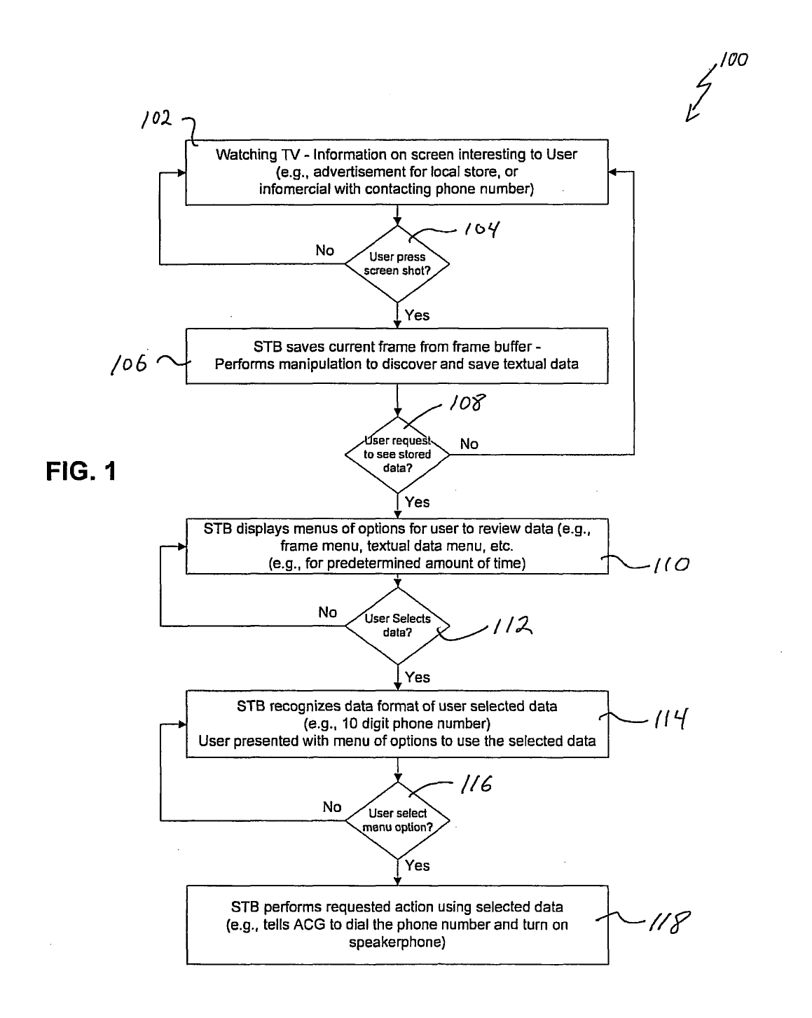

FIG. 1 shows an exemplary implementation of the method 100 for video screen capture and scrape according to an embodiment of the invention. Initially (step 102) as user is watching television and some information presented on the screen is of interest to the user (e.g., an advertisement for a local store, an infomercial, etc.). At this point, the user has the option to press a screen shot button on their remote or on the STB itself (step 104). When the user has selected the screen shot mode, the STB saves the current frame in the frame buffer (step 106). The STB can then conduct further processing to “scrape” the saved frame to discover and save any textual data contained within the same. Examples of such scraping processing can include, but are not limited to, optical character recognition (OCR) operations, etc. Those of skill in the art will appreciate that other known OCR or text extraction tools can be implemented into the preferred embodiment of the invention without departing from the intended scope of the same.

The user can then request at any point to see the stored data (step 108). This request can be performed through graphical user interfaces (GUIs), such as menus (e.g., a frame menu, a text menu, etc.). Here the user can be presented with an option as to which display of the information they would like. For example, the user can request to view the frame shot stored in the frame buffer, or the view can request the STB to display the textual data that has been scraped from the stored frame. The STB then displays the requested data to the user (step 110). This display can be for a predetermined amount of time, or until the user changes the menu display by pressing an exit/back key or the like.

The user can do with the displayed data as they see fit, and then delete the same or keep it in the STB memory for later reference.

In accordance with further implementations of the present invention, the STB can provide the user with options on what to do with the data. For example, after the display of the data to the user at step 110, the user can be provided with the ability to select particular data (step 112) and in response, the STB recognizes the data format of such selection and provide the user with a menu of options relating to the selected data (Step 114). The menu options provided to the user by the STB will be dependent on the nature of the textual data obtained from the screen scrape function. In accordance with other contemplated embodiments, an auto-detect feature can be implemented to automatically detect certain styles of data from the screen scrape function and offer options to the user without requiring their interaction. For example, data like a street address, a web address or a phone number can be extracted and various options presented to the user based on the same. In this implementation, as soon as the user decides to capture the screen and access the data, some options can be provided to the user without requiring their specific selection of that data. If the user does not like any of the automatically presented options, they can interact more with the data.

By way of example, if the selected data relates to a telephone number, the STB could provide the user with options for using the telephone number. Such options can include, but are not limited to, communicating with a home gateway 210 (e.g., an advanced cable gateway—ACG) and request to call the number and place the call on speakerphone. Another possible function with a telephone number could include performing a lookup of the owner of the phone number (i.e., reverse phone number search), etc. If the user selected data is, for example, a website address, the STB could open an Internet connection and enable the user to navigate directly to that website. Alternatively, the STB could send the web page to the users ACG and the ACG would format a page and send it to the STB for display. Another example of potentially relevant data obtained from the screen capture function could be the date. In this example, the date could be automatically cross-referenced to a calendar or other calendar services to allow the user to set a reminder on their calendar. Alternatively, the date data could be cross-referenced with an address or a performance schedule for concerts, plays or the like.

If the user selected data is, for example, the website address for a local food establishment, the STB could provide the user with the option to see the menu for that local food establishment by also navigating through to the associated website.

If the user selected data is a street address, the ACG or STB could open a web page showing that location on a map. In any of the above examples or other information not discussed above, the STB could automatically input the same into a search engine to find more information to provide to the user that relates to the selected data. Another option could be to compile groups of data like phone numbers, addresses, etc, and put them into an address book, for example for populating the ACG's address book with the contact information for the user's favorite restaurant, etc.

When the user selects one of the options provided by the STB (step 116), the STB will perform the requested action using the selected data (step 118).

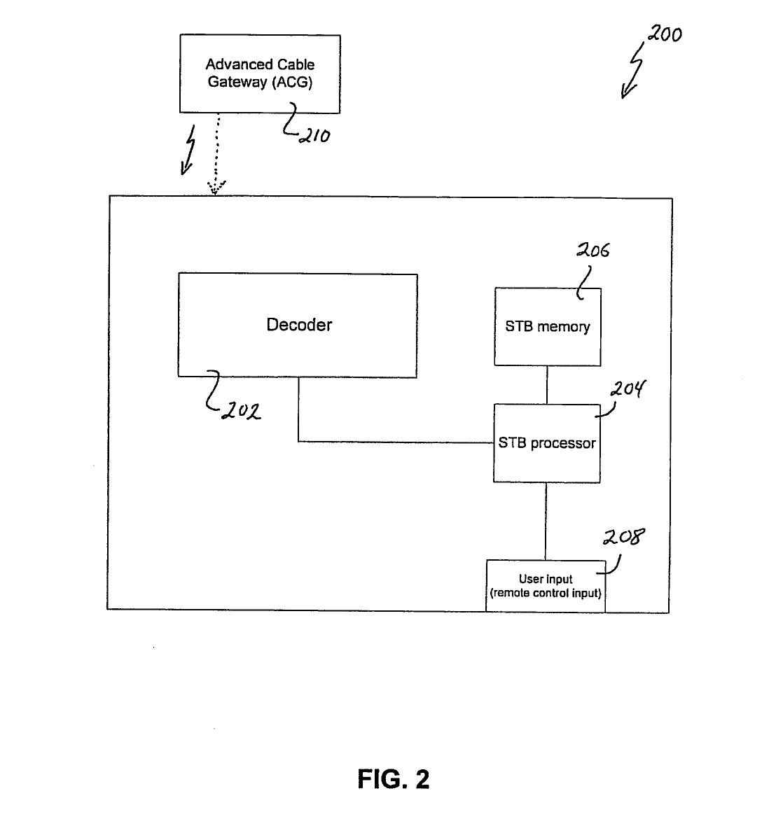

Referring to FIG. 2, there is shown an exemplary STB 200 into which the present invention can be implemented. The STB 200 includes a decoder 202 which receives the encoded signals from a service provide via a connection point on the STB (not shown). The STB Processor 204 is in signal communication with the decoder 202 and with the STB memory 206. A user input 208 is also provided and generally takes the form of a wireless remote control device but can also include buttons on the STB itself that works with a menu driven GUI. Those of skill in the art will appreciate that the processing of the screen shot and the extraction (scraping) of textual data from the screen shot and all other processing and display functions of the present invention can be implemented in the STB 200 through associated programming of the processor 204 with memory 206.

As mentioned above, in another embodiment the STB 200 is in communication with the user's home gateway 210 (e.g., ACG), either by a wireless communication protocol or by a wired connection. The ACG 210 can be used to expand upon available options presented to the user when determining what to do with the text information extracted during the screen scrape function of the invention.

These and other features and advantages of the present principles can be readily ascertained by one of ordinary skill in the pertinent art based on the teachings herein. It is to be understood that the teachings of the present principles can be implemented in various forms of hardware, software, firmware, special purpose processors, or combinations thereof.

Most preferably, the teachings of the present principles are implemented as a combination of hardware and software. Moreover, the software can be implemented as an application program tangibly embodied on a program storage unit. The application program can be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform can also include an operating system and microinstruction code. The various processes and functions described herein can be either part of the microinstruction code or part of the application program, or any combination thereof, which can be executed by a CPU. In addition, various other peripheral units can be connected to the computer platform such as an additional data storage unit and a printing unit.

It is to be further understood that, because some of the constituent system components and methods depicted in the accompanying drawings are preferably implemented in software, the actual connections between the system components or the process function blocks can differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications can be effected therein by one of ordinary skill in the pertinent art without departing from the scope or spirit of the present principles. All such changes and modifications are intended to be included within the scope of the present principles as set forth in the appended claims.

1. A method comprising the steps of:
identifying whether a screen capture input has been received;
saving a frame in response to a received screen capture input;
scraping the saved frame to discover and save textual data contained within the saved frame; and
displaying a menu of options to a user in response to a request to see data related to the saved frame.

2. The method of claim 1, further comprising the steps of:
recognizing a data format corresponding to the request; and
presenting the user with a menu of options to use the recognized data format.

3. The method of claim 2, further comprising the step of performing a user selection option with the recognized data format.

4. The method of claim 1, wherein said scraping comprises performing an optical character recognition (OCR) function to identify and extract any text in the saved frame.

5. An apparatus comprising:
means for identifying whether a screen capture input has been received;
means for saving a frame in response to a received screen capture input;
means for scraping the saved frame to discover and save textual data contained within the saved frame; and
means for displaying a menu of options to a user in response to a request to see data related to the saved frame.

6. The apparatus of claim 5, further comprising:
means for recognizing a data format corresponding to the user's request; and
means for presenting the user with a menu of options to use the recognized data format.

7. The apparatus of claim 6, further comprising means for performing a user selection option with the recognized data format.

8. The apparatus of claim 5, wherein said means for scraping comprises means for performing an optical character recognition (OCR) function to identify and extract any text in the saved frame.

9. A processor readable medium having stored thereon instructions for causing a processor to perform at least the following:
identifying whether a screen capture input has been received;
saving a frame to a frame buffer in response to a received screen capture input;
scraping the saved frame to discover and save textual data contained within the saved frame; and
displaying a menu of options to a user in response to their request to see data related to the saved frame.

10. The processor readable medium of claim 9, further comprising instructions stored thereon for causing the processor to further perform:
recognizing a data format corresponding to the user's request; and
presenting the user with a menu of options to use the recognized data format.

11. The processor readable medium of claim 10, further comprising instructions stored thereon for causing the processor to further perform a user selection option with the recognized data format.

12. The processor readable medium of claim 9, further comprising instructions stored thereon for causing the processor to perform said scraping by performing an optical character recognition (OCR) function to identify and extract any text in the saved frame.

13. An apparatus comprising:
a decoder configured to receive and decode encoded signals from a service provider;
a memory configured to store data;
a user input configured to receive inputs from a user; and
a processor configured to identify whether a screen capture input has been received by the user input, save a frame in the memory in response to a received screen capture input, scrape the frame in the memory to discover and save textual data saved within the frame, and display a menu of options to a user in response to a request to see data related to the saved frame.

14. The apparatus of claim 13, wherein the processor is further configured to recognize a data format corresponding to a user's request, and present the user with a menu of options to use the recognized data format.

15. The apparatus of claim 14, wherein the processor is further configured to perform a user selection option with the recognized data format.

16. The apparatus of claim 13, wherein scraping a frame comprises performing an optical character recognition (OCR) function to identify and extract any text in the saved frame.
